(19) United States
(12) Patent Application Publication
(10) Pub. No.: US 2011/0057862 A1
(43) Pub. Date: Mar. 10, 2011

(54) IMAGE DISPLAY DEVICE

(76) Inventor: Hsin-Liang Chen, Taipei County (TW)

(21) Appl. No.: 12/554,929

(22) Filed: Sep. 7, 2009

(51) Int. Cl. G09G 5/00

(52) U.S. Cl. 345/3.1; 345/8

(57) ABSTRACT

An image display device is disclosed. The image display device includes: an image processing unit; a projecting system; a head-mounted display; and a switch mirror disposed between the projecting system and the head-mounted display for switching lights projected from the image processing unit to the head-mounted display or the projecting system.

### BACKGROUND OF THE INVENTION

1. Field of the Invention

The invention relates to an image display device, and more particularly an integrated image display device having both projecting system and head-mounted display.

2. Description of the Prior Art

Projectors are conventionally used in conference briefings in which a host projects data or graphics onto a screen for familiarizing attendants with a presentation. With the rapid development of technology, projectors are now widely used in other applications. With high-power hi-fi equipment, large-capacity digital video discs (DVDs), and the large images that can be generated by projectors, it is now possible to reconstruct at home visual and audio effects similar to those provided in a movie theater.

A head-mounted display (HMD), a three-dimensional visual optical device, is the first device providing its wearer with an immersive experience. The typical HMD houses two miniature display screens and an optical system that channels the images from the screens to the eyes, thereby presenting a stereo view of a virtual world. Recently, the head mounted display as an input apparatus in response to a user's action is widely utilized in an augmented reality or a virtual reality system. Continuously measuring the position and orientation of the user's head by means of a motion tracker allows an image generating computer to adjust a scene representation to a current view. As a result, the viewer can look around and walk through the surrounding virtual environment. In addition, text and images can be projected on a screen for viewing by the user therefore realizing an augmented reality or a virtual reality environment.

However, the projectors and head-mounted displays sold on the market are individual unit. If a consumer wishes to use functions from both devices at the same time, he or she needs to prepare two different set of equipments thereby causing a great deal of burden. Hence, how to provide a small and easy to carry image device with functions of both projector and head-mounted display has become a popular topic on consumer market.

### SUMMARY OF THE INVENTION

It is an objective of the present invention to provide an integrated image display module for allowing users to enjoy functions of both projector and head-mounted display by using only one image device.

According to a preferred embodiment of the present invention, an image display device is disclosed. The image display device includes: an image processing unit; a projecting system; a head-mounted display; and a switch mirror disposed between the projecting system and the head-mounted display for switching lights projected from the image processing unit to the head-mounted display or the projecting system.

Another aspect of the present invention discloses an image display device, which includes: an image processing unit; a projecting system; a head-mounted display; and a beam splitter disposed between the projecting system and the head-mounted display for directing lights projected from the image processing unit to the head-mounted display and the projecting system simultaneously.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of an image display device module according to a first embodiment of the present invention.

FIG. 2 illustrates a perspective view of an image display device module according to a second embodiment of the present invention.

FIG. 3 illustrates a perspective view of an image display device module according to a third embodiment of the present invention.

FIG. 4 illustrates a perspective view of an image display device module according to a fourth embodiment of the present invention.

### DETAILED DESCRIPTION

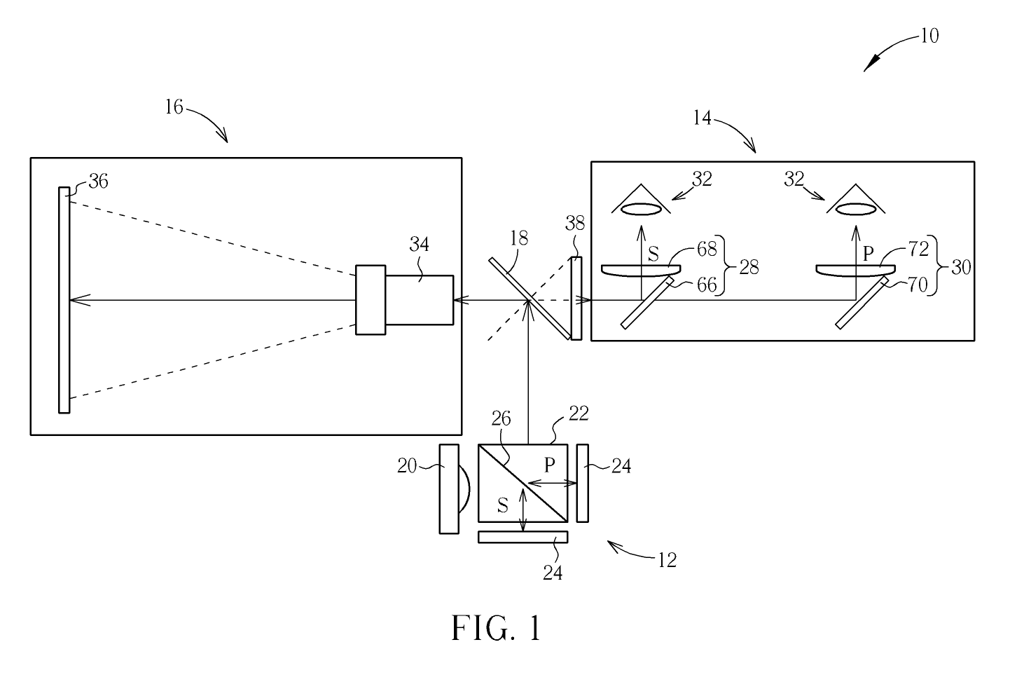

Referring to FIG. 1, FIG. 1 illustrates a perspective view of an image display device 10 module according to a first embodiment of the present invention. Preferably, the image display device 10 could be constructed to project three-dimensional pictures or regular two-dimensional pictures, and an embodiment for projecting three-dimensional pictures is explained below. As shown in FIG. 1, the image display device 10 includes an image processing unit 12, a head-mounted display 14, a projecting system 16, and a switch mirror 18 disposed between the head-mounted display 14 and the projecting system 16. The image processing unit 12 includes a light source 20, a prism group 22, and two liquid crystal on silicon (LCoS) display panels 24. The light source 20 provides light required by the image display device 10, in which the light source 20 could be composed of various light emitting elements including light emitting diodes (LEDs) or high intensity light bulbs. The prism group 22 is situated relative to the exit of the light source 20. A polarizing beam splitter (PBS) 26 is coated on the prism group 22 to redefine the unpolarized light projected from the light source 20 into P-polarizing beam and S-polarizing beam. The defined P-polarizing beam and the S-polarizing beam are reflected from the two LCoS display panels 24 to the switch mirror 18, and later reflected by the switch mirror 28 to the head-mounted display 14 or the projecting system 16.

The head-mounted display 14 of the image display device 10 has at least one polarizer group 28 and a lens group 30. The polarizer group 28 is composed of a polarizer 66 and a lens 68, while the lens group 30 is composed of a reflecting mirror 70 and a lens 72. The polarizer 66 of the polarizer group 28 preferably reflects the S-polarizing beam to the lens 68 while the reflecting mirror 70 of the lens group 30 preferably reflects the P-polarizing beam to the lens 72. The S-polarizing beam and the P-polarizing beam focused by the lenses 68/72 are projected to the retina of the human eyes 32 to form enlarged images.

The projecting system 16 disclosed in this embodiment is preferably a micro-projector, in which the projecting system 16 is primarily composed of a projecting lens group 34 and a screen 36. Similar to the manner of projecting light beams, P-polarizing beam and S-polarizing beam reflected from the switch mirror 18 are projected through the projecting lens group 34 and shown on the screen 36. As three-dimensional images are shown on the screen 36, surrounding audience could use 3D glasses to enjoy the image produced.

It should be noted that the intensity of light plays a dominating factor in the quality of images produced from the projecting system 16 and the head-mounted display 14. For example, projecting system 16 has the tendency to produce better images by having a strong light source, whereas the head-mounted display 14 usually requires a weaker light source to prevent strong light beams from causing discomfort to the eyes of user. Therefore, the present invention preferably provides lights of different intensity to the projecting system 16 and the head-mounted display 14 as they are integrated.

According to an embodiment of the present invention, an attenuator 38 could be disposed between the switch mirror 18 and the head-mounted display 14 for adjusting the intensity of light entering the head-mounted display 14. The attenuator 38 could be a variable attenuator used to produce different light intensity according to different time (such as daytime or nighttime) and environment (such as indoor or outdoor), or an optical film coated on surface of the switch mirror 18 with respect to the head-mounted display 14, in which the attenuator 38 could be controlled automatically or manually through a sensor. The attenuator 38 of this embodiment is preferably coated on surface of the switch mirror 18, but could also be coated on the polarizer 66 of the head-mounted display 14 adjacent to the eyes 32 of user, which is also within the scope of the present invention.

Preferably, as the switch mirror 18 is used to switch light to different targets (such as head-mounted display 14 or projecting system 16), the attenuator 38 is used to control the intensity of lights entering either the head-mounted display 14 of the projecting system 16, such that the projecting system 16 would receive a relatively stronger lights whereas the head-mounted display 14 would receive relatively weaker lights. Despite the attenuator 38 is directly coated on surface of the switch mirror 18, another attenuator 38 could also be placed on the polarizer 66 of the head-mounted display 14 regardless of whether attenuator is placed on the switch mirror 18, which is also within the scope of the present invention.

In addition to using the attenuator 38 for controlling the intensity of lights entering the head-mounted display 14, the switch mirror 18 could also be used for performing similar function. For example, a switch mirror 18 having at least two reflecting surface with different reflectivity could be provided to control the intensity of lights entering the head-mounted display 14 and the projecting system, such that the projecting system 16 would receive relatively stronger lights whereas the head-mounted display 14 would receive relatively weaker lights. This design preferably provides a similar outcome as the aforementioned embodiment of using attenuator. However, an attenuator 38 could also be disposed along with this design, which is also within the scope of the present invention.

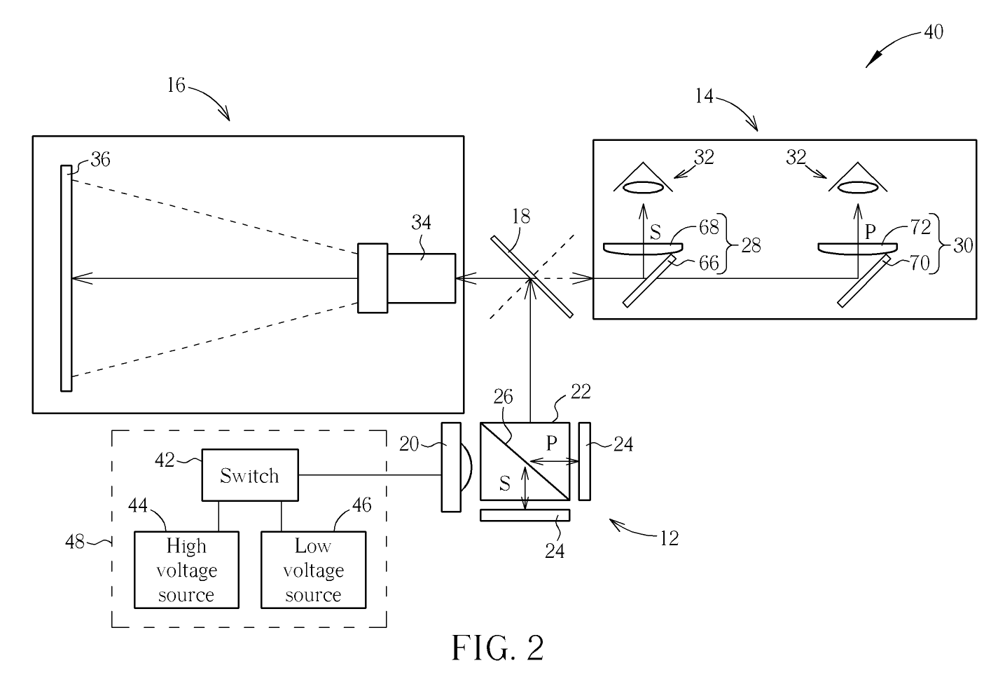

Referring to FIG. 2, FIG. 2 illustrates an image display device 40 module according to a second embodiment of the present invention. Similar to the module disclosed in the first embodiment, the image display device 40 includes an image processing unit 12, a head-mounted display 14, a projecting system 16 and a switch mirror 18 disposed between the head-mounted display 14 and the projecting system 16. The image processing unit 12 is composed of a light source 20, a prism group 22, and two LCoS display panels 24.

The head-mounted display 14 of the image display device 10 has one polarizer group 28 and a lens group 30, in which the polarizer group 28 is composed of a polarizer 66 and a lens 68 while the lens group 30 is composed of a reflecting mirror 70 and a lens 72. The polarizer 66 of the polarizer group 28 preferably reflects the S-polarizing beam to the lens 68 while the reflecting mirror 70 of the lens group 30 preferably reflects the P-polarizing beam to the lens 72. The S-polarizing beam and the P-polarizing beam focused by the lenses 68/72 are projected to the retina of the human eyes 32 to form enlarged images. The projecting system 16 disclosed in this embodiment is preferably a micro-projector, in which the projecting system 16 is primarily composed of a projecting lens group 34 and a screen 36. Similar to the manner of projecting light beams from the head-mounted display 14, P-polarizing beam and S-polarizing beam reflected from the switch mirror 18 are projected through the projecting lens group 34 and shown on the screen 36.

In this embodiment, a light source control unit 48 is connected to the light source 20 of the image processing unit 40 for controlling the intensity of the light entering the projecting system 16 or the head-mounted display 14, in which the light source control unit 48 is preferably composed of a switch 42, a high voltage source 44 and a low voltage source 46. If the projecting system 16 requests a stronger light source, the switch 42 could be utilized to provide larger current to the light source 20 for transmitting light of strong intensity to the projecting system 16. Conversely, a small current could be provided to the light source 20 through the switch 42 for transmitting weaker lights to the head-mounted display.

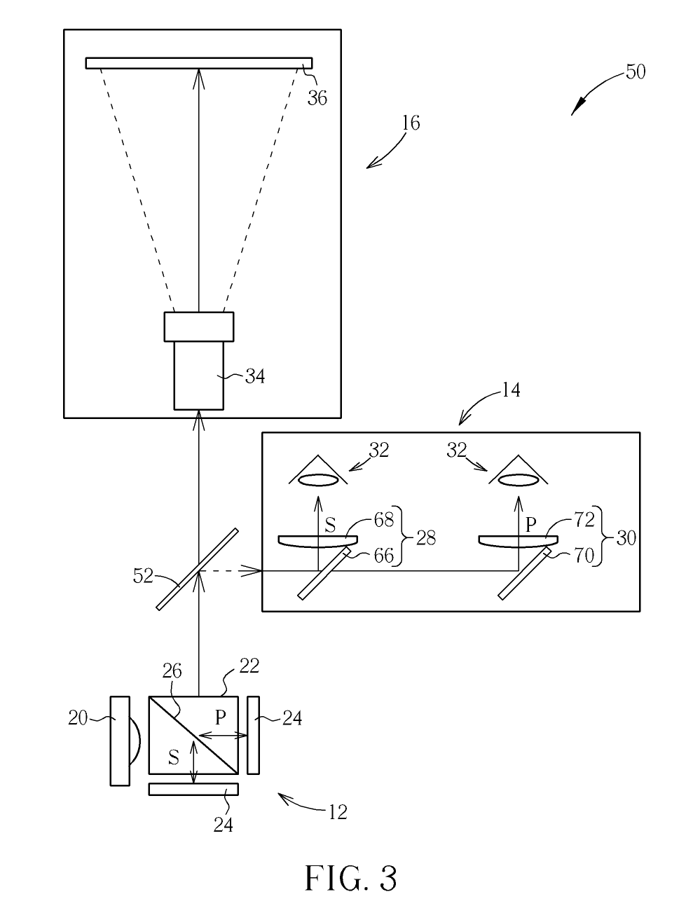

Referring to FIG. 3, FIG. 3 illustrates a perspective view of an image display device 50 module according to a third embodiment of the present invention. In this embodiment, the image display device 50 includes an image processing unit 12, a head-mounted display 14, a projecting system 16, and a beam splitter 52 disposed between the head-mounted display 14 and the projecting system 16. The image processing unit 12 includes a light source 20, a prism group 22, and two liquid crystal on silicon (LCoS) display panels 24. The light source 20 provides light required by the image display device 50, in which the light source 20 could be composed of various light emitting elements including light emitting diodes (LEDs) or high intensity light bulbs. The prism group 22 is situated relative to the exit of the light source 20. A polarizing beam splitter (PBS) 26 is coated on the prism group 22 to redefine the unpolarized light projected from the light source 20 into P-polarizing beam and S-polarizing beam. The defined P-polarizing beam and the S-polarizing beam are reflected from the two LCoS display panels 24 to the beam splitter 52, and later reflected by the beam splitter 52 to the head-mounted display 14 and the projecting system 16 simultaneously.

In contrast to the aforementioned embodiments shown in FIGS. 1-2 of using the switch mirror 18 to reflect lights to the head-mounted display 14 or the projecting system 16 separately, such that only one function of the device could be used at a time, this embodiment preferably uses the beam splitter 52 to provide lights with different intensity to the head-mounted display 14 and the projecting system 16 simultaneously, thereby allowing users to enjoy these two functions at the same time. Preferably, the two surfaces of the beam splitter 52 corresponding to the head-mounted display 14 and the projecting system 16 could be fabricated with different reflectivity and transparency to provide different intensity of lights to the head-mounted display 14 and projecting system 16. Moreover, an additional attenuator could be disposed selectively in the head-mounted display 14, which is also within the scope of the present invention.

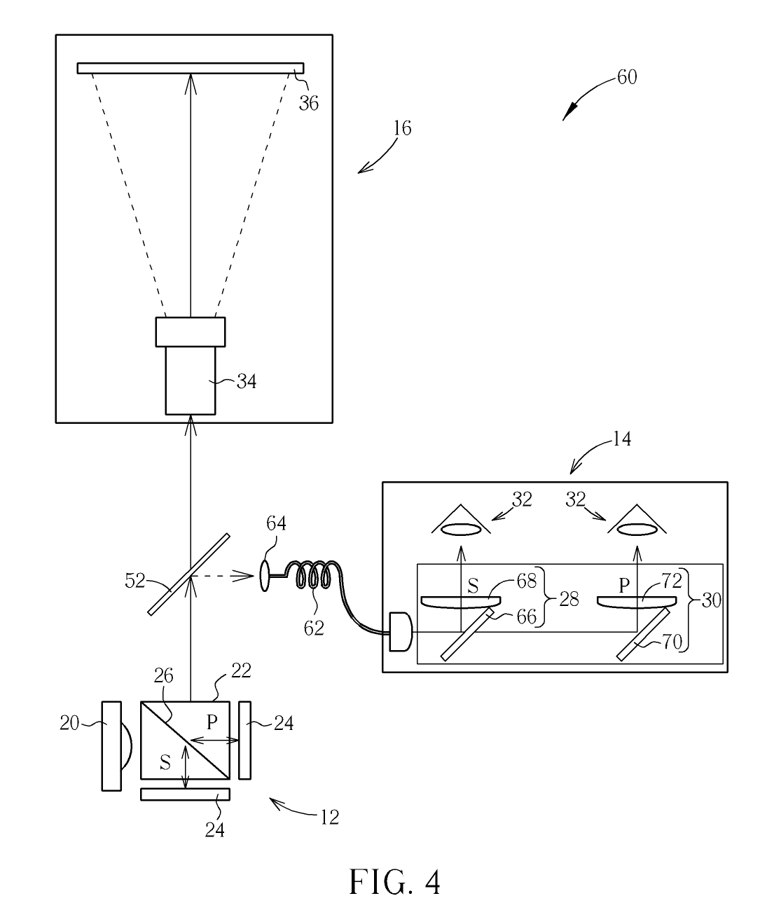

Referring to FIG. 4, FIG. 4 illustrates a perspective view of an image display device 60 module according to a fourth embodiment of the present invention. In this embodiment, the image display device 60 includes an image processing unit 12, a head-mounted display 14, a projecting system 16, and a beam splitter 52 disposed between the head-mounted display 14 and the projecting system 16. The image processing unit 12 includes a light source 20, a prism group 22, and two liquid crystal on silicon (LCoS) display panels 24. The light source 20 provides light required by the image display device 60, in which the light source 20 could be composed of various light emitting elements including light emitting diodes (LEDs) or high intensity light bulbs. The prism group 22 is situated relative to the exit of the light source 20. A polarizing beam splitter (PBS) 26 is coated on the prism group 22 to redefine the unpolarized light projected from the light source 20 into P-polarizing beam and S-polarizing beam. The defined P-polarizing beam and the S-polarizing beam are reflected from the two LCoS display panels 24 to the beam splitter 52, and later reflected by the beam splitter 52 to the head-mounted display 14 and the projecting system 16 simultaneously.

In this embodiment, an optical fiber 62 is connected to the head-mounted display 14 and the projecting system 16 for controlling the operation of these two units. The optical fiber 62 is preferably utilized to control the head-mounted display 14 and the projecting system 16 remotely, but not limited thereto. Additionally, the head-mounted display 14 and the projecting system 16 could be controlled through physical connection of HDMI signal lines or other signal lines, or could be controlled through wireless transmission. In other words, a physical connection or remote control means could be established to control only the head-mounted display 14, only the projecting system 16, or both the head-mounted display 14 and the projecting system 16 simultaneously. An image enhancer 64 could also be connected to the optical fiber 62 to enhance the image quality of the image display device 60. It should be noted that despite only one single connection is established between the optical fiber 62 and the head-mounted display 14 in this embodiment, multiple connections could also be achieved by connecting the optical fiber 62 with a plurality of head-mounted displays 14 and/or projecting systems 16 to allow multiple of users to enjoy both functions simultaneously. Lastly, it should be noted that all devices and quantity, size and corresponding position of the module disclosed in the aforementioned embodiments are not limited by the figures presented. The presented figures are merely for exemplary purpose and other design and arrangement achieving analogous functionality could also be applied to the device of the present invention accordingly, which is also within the scope of the present invention.

Those skilled in the art will readily observe that numerous modifications and alterations of the device and method may be made while retaining the teachings of the invention.

What is claimed is:

1. An image display device, comprising:
an image processing unit;
a projecting system;
a head-mounted display; and
a switch mirror disposed between the projecting system and the head-mounted display for switching lights projected from the image processing unit to the head-mounted display or the projecting system.

2. The image display device of claim 1, further comprising an attenuator disposed between the switch mirror and the head-mounted display.

3. The image display device of claim 2, wherein the attenuator is a variable attenuator.

4. The image display device of claim 2, wherein the attenuator is an optical film coated on surface of the switch mirror.

5. The image display device of claim 1, wherein the head-mounted display further comprises a polarizer.

6. The image display device of claim 5, further comprising an attenuator coated on the polarizer.

7. The image display device of claim 1, wherein the switch mirror further comprises two different types of reflectivity.

8. The image display device of claim 1, wherein the image process unit comprises a light source, a prism group, and at least one LCoS display panel.

9. The image display device of claim 8, further comprising a light source switching device disposed before the light source for controlling the intensity of light projected from the light source.

10. An image display device, comprising:
an image processing unit;
a projecting system;
a head-mounted display; and
a beam splitter disposed between the projecting system and the head-mounted display for directing lights projected from the image processing unit to the head-mounted display and the projecting system simultaneously.

11. The image display device of claim 10, further comprising an optical fiber for controlling the head-mounted display remotely.

12. The image display device of claim 10, further comprising an optical fiber for controlling the projecting system remotely.

13. The image display device of claim 10, further comprising an optical fiber for controlling the projecting system and the head-mounted display remotely.

14. The image display device of claim 10, further comprising an image enhancer connecting to an optical fiber for enhancing image received by the head-mounted display and the projecting system.

15. The image display device of claim 10, wherein the image processing unit comprises a light source, a prism group, and at least one LCoS display panel.
